(19) United States
(12) Patent Application Publication
(10) Pub. No.: US 2005/0219859 A1
(43) Pub. Date: Oct. 6, 2005

(54) Light guide

(76) Inventor: Te-Hsiang Fang, Taipei Hsien (TW)

Correspondence Address: BRUCE H. TROXELL, SUITE 1404, 5205 LEESBURG PIKE, FALLS CHURCH, VA, 22041, US

(21) Appl. No.: 10/815,863

(22) Filed: Apr. 2, 2004

(51) Int. Cl. F21V 8/00

(52) U.S. Cl. 362/554; 362/579; 362/118

(57) ABSTRACT

A light guide comprising a light guide element, and a plurality of optical fiber disposed inside of said light guide element for forming at least one light passage in between two ends of said light guide element.

### BACKGROUND OF THE INVENTION

1. Field of the Invention

The present invention relates to a light guide and, more particularly, such a light guide practical for use in a small personal item having light means.

2. Description of the Related Art

Small personal items with light means such as light pens, mini flashlights, light key-rings, etc. are commercially available. These items commonly have a lighting circuit formed of a battery, a bulb, and a press-button switch. When switched on the press-button switch, the bulb is turned on to emit light. Different colors of bulbs may be used to emit different colors of light. These items can be used as a company's gifts to its employees as well as clients. Previously, the inventor invented a similar design, which is a light pen that comprises a lighting device mounted in the penholder, and a cylindrical light guide fastened to the pen cap and aimed at the lighting device. The light guide in the previous invention is molded from transparent plastics, having longitudinally extended light guide holes. When turning on the bulb, light passes from the bulb through the light guide holes of the light guide, producing a light column that attracts people eyes. This design of light guide is still not satisfactory in function. Because the light guide is a solid plastic member, it is difficult to put a design inside the light guide. When putting a design inside the light guide, the molding cost is high.

### SUMMARY OF THE INVENTION

The present invention has been accomplished under the circumstances in view. It is therefore the main object of the present invention to provide a light guide, which eliminates the aforesaid drawbacks.

According to one aspect of the present invention, the light guide comprises a light guide element, and a plurality of optical fiber disposed inside of said light guide element for forming at least one light passage in between two ends of said light guide element.

According to another aspect of the present invention, a message is put upon the light guide element after molding the light guide element. The message can be a logo, sign, graphic device, blurb, etc. subject to clients' requirements.

### BRIEF DESCRIPTION OF THE DRAWINGS

FIG. 1 illustrates a light pen mounted with a light guide according to the present invention.

FIG. 2 is a schematic drawing showing the light guide connected to the lighting device according to the present invention.

FIG. 3 is a cross sectional view in an enlarged scale of the cap of the light pen shown in FIG. 1.

FIG. 4 is an elevation view of a light guide according to the present invention.

FIG. 5 is a top plain view of the light guide element for the light guide according to the present invention.

FIG. 6 is a cross sectional view of the light guide according to the present invention.

FIG. 7 is a top plain view of the light guide element for the light guide according to the present invention after branding of the message.

FIG. 8 is a cross sectional view of the light guide according to another embodiment of the present invention.

### DETAILED DESCRIPTION OF THE PREFERRED EMBODIMENT

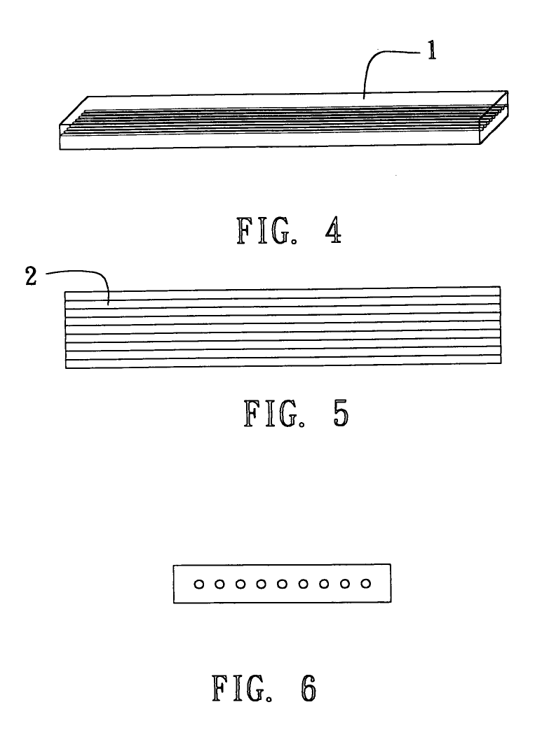

Referring to FIG. 4, a light guide is comprised a light guide element 1, and a plurality of optical fiber 2 disposed inside of said light guide element 1 for forming at least one light passage 3 in between two ends of said light guide element 1. Wherein, the light guide element 1 is example but not limited to be made of transparent material, having a smooth outer surface. The plurality of optical fiber 2 is disposed inside of said light guide element 1 and made by molding method within the light guide element 1, preferably.

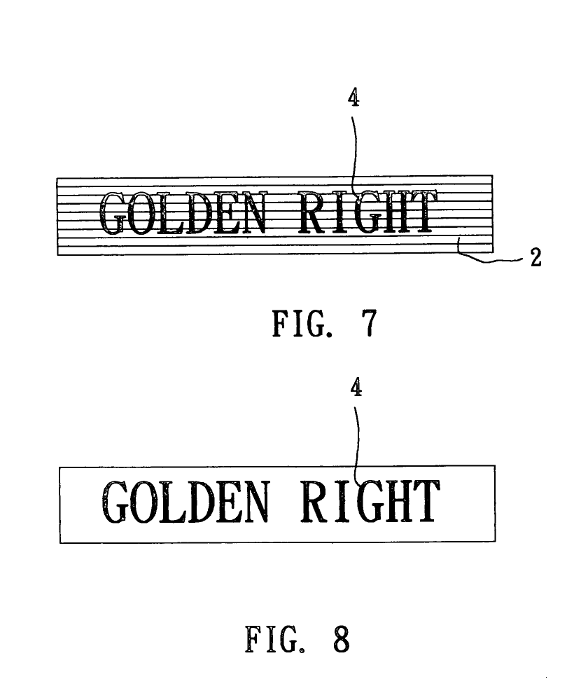

A message 4, for example, “GOLDEN RIGHT” is put upon the smooth surface of the light guide element 1 (see FIG. 7). Therefore, light passages 3 are formed in the light guide between the two ends of the light guide element 11 (see FIG. 6). Furthermore, the smooth surface of the light guide element 1 also could be masked by certain material and then put the message 4 upon said light guide element (see FIG. 8). Furthermore, the message 4 further comprises a twinkling function so as to increase the visibility of the light guide.

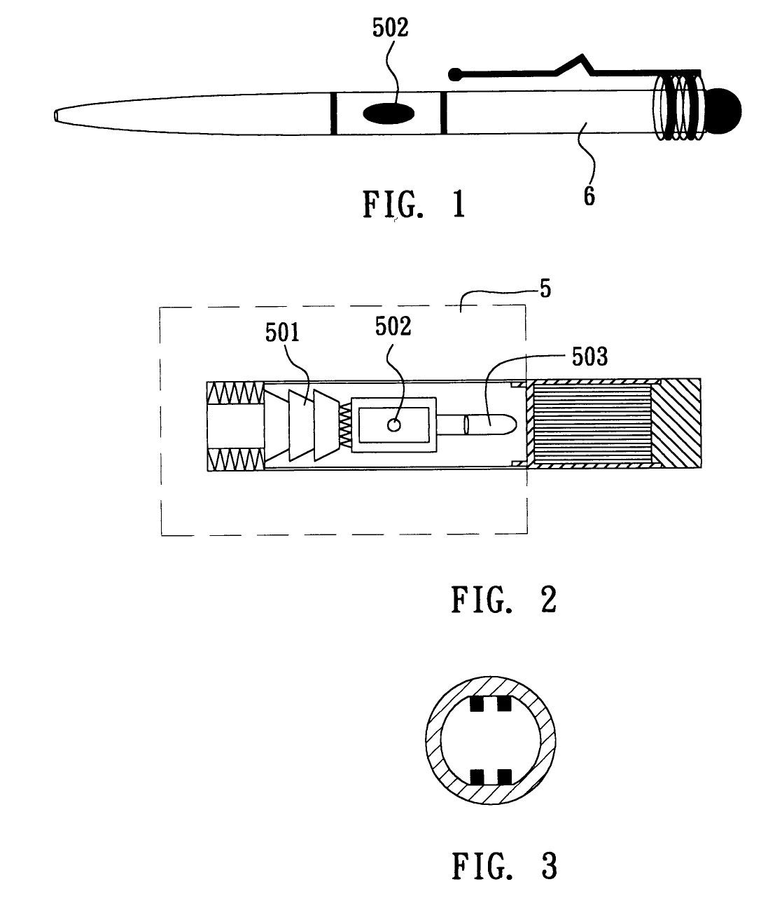

FIGS. 1˜3 show the light guide used in a light pen. The light guide is mounted in the inside chamber of the pen cap 6 of the light pen (see FIG. 3). At the left side of the light guide is provided a lighting device 5, which is comprised of a battery 501, a press-button switch 502, and a bulb 503. When switched on the press-button switch 502, the bulb 503 is turned on to emit light toward the light passages 3 of the light guide, and therefore the message “GOLDEN RIGHT” is illuminated. The light pen can be used as a gift of a company to its employee or client.

In the aforesaid embodiment, the light guide element 1 can be rectangular plates, half-round bar, and triangular bar. Alternatively, the light guide shaped like a rectangular plate, cylindrical bar, or prism.

The message 4 can be printed on the smooth surface of the light guide element, or put upon the smooth surface of the light guide element 1 by a hot iron.

In the aforesaid application example, the light guide is used in a light pen. Alternatively, the light guide can be used in a flashlight, or a light key-ring.

Although particular embodiments of the invention have been described in detail for purposes of illustration, various modifications and enhancements may be made without departing from the spirit and scope of the invention. Accordingly, the invention is not to be limited except as by the appended claims.

1. A light guide comprising a light guide element, and a plurality of optical fiber disposed inside of said light guide element for forming at least one light passage in between two ends of said light guide element.

2. The light guide as claimed in claim 1, further comprising a message is put upon said light guide element.

3. The light guide as claimed in claim 1, further comprises masking said light guide element and then putting a message upon said light guide element.

4. The light guide as claimed in claim 2, wherein said message further comprises a twinkling function.

5. The light guide as claimed in claim 2, wherein said message can be printed on the smooth surface of the light guide element.

6. The light guide as claimed in claim 2, wherein said message can be put upon the smooth surface of the light guide element by a hot iron.

7. The light guide as claimed in claim 1, wherein said light guide element is shaped like a rectangular plate, a round bar, or a triangular bar.

8. The light guide as claimed in claim 1, wherein said light guide element and said a plurality of optical fiber are molded, respectively.

9. The light guide as claimed in claim 1, wherein said light guide element is made of transparent material and has a smooth outer surface, preferably.

10. The light guide as claimed in claim 3, wherein said message further comprises a twinkling function.

11. The light guide as claimed in claim 3, wherein said message can be printed on the smooth surface of the light guide element.

12. The light guide as claimed in claim 3, wherein said message can be put upon the smooth surface of the light guide element by a hot iron.
